(19) United States
(12) Patent Application Publication
(10) Pub. No.: US 2018/0218815 A1
(43) Pub. Date: Aug. 2, 2018

(54) MAGNETIC SHEET AND ELECTRONIC DEVICE

(71) Applicant: SAMSUNG ELECTRO-MECHANICS CO., LTD., Suwon-si (KR)

(72) Inventors: Seung Min LEE, Suwon-si (KR); Jung Young CHO, Suwon-si (KR); Chang Hak CHOI, Suwon-si (KR)

(73) Assignee: SAMSUNG ELECTRO-MECHANICS CO., LTD., Suwon-si (KR)

(21) Appl. No.: 15/723,414

(22) Filed: Oct. 3, 2017

(30) Foreign Application Priority Data
Feb. 2, 2017 (KR) 10-2017-0015061

(51) Int. Cl. H01F 3/02; H01F 38/14; H02J 50/10; H02J 7/02

(52) U.S. Cl. CPC H01F 3/02; H02J 7/025; H02J 50/10; H01F 38/14

(57) ABSTRACT

A magnetic sheet includes one or more magnetic layers formed of a metal, the magnetic layer includes first and second regions having different degrees of crystallinity from each other.

### CROSS-REFERENCE TO RELATED APPLICATION(S)

This application claims the benefit under 35 USC § 119(a) of Korean Patent Application No. 10-2017-0015061 filed on Feb. 2, 2017 in the Korean Intellectual Property Office, the entire disclosure of which is incorporated herein by reference for all purposes.

### BACKGROUND

### 1. Field

The present disclosure relates to a magnetic sheet and an electronic device.

### 2. Description of Related Art

Functions, such as wireless power consortium (WPC) standard function, near field communications (NFC) function, and magnetic secure transmission (MST) function have increasingly been used in portable mobile apparatuses. WPC technology, NFC technology, and MST technology have differences, such as different operating frequencies, different data transmission rates, and different power transmission amounts.

In a wireless power transmitting apparatus, a magnetic sheet that blocks and collects electromagnetic waves is used. For example, in a wireless charging apparatus, the magnetic sheet is disposed between a reception coil and a battery. The magnetic sheet shields and collects a magnetic field generated in the reception part coil and blocks the magnetic field from arriving at the battery. Thus, allowing electromagnetic waves generated by the wireless power transmitting apparatus to be efficiently received by a wireless power receiving apparatus.

In accordance with multi-functionalization and improvements of the functions of portable electronic apparatuses in which such magnetic sheets are used, improvements in performance of magnetic sheets is continuously demanded.

It has become important to utilize space efficiently when performing the WPC function, the NFC function, and the MST function, due to miniaturization and the decrease of the weight of the electronic devices. However, operating frequencies for the WPC technology, the NFC technology, and the MST technology, is different from one another, and degrees of magnetic permeability of required shielding parts are different from one another, such that the magnetic sheets formed of heterogeneous magnetic materials should be used, which may be difficult.

### SUMMARY

This Summary is provided to introduce a selection of concepts in a simplified form that are further described below in the Detailed Description. This Summary is not intended to identify key features or essential features of the claimed subject matter, nor is this Summary intended to be used as an aid in determining the scope of the claimed subject.

In one general aspect, there is provided a magnetic sheet may including a magnetic layer formed of a metal, wherein the magnetic layer comprises first and second regions having different degrees of crystallinity from each other.

The first and the second region may have different degrees of magnetic permeability.

The first region may be disposed in a central portion of the magnetic layer, and the second region may surround the first region.

A degree of crystallinity of the second region may be higher than a degree of crystallinity of the first region.

A number of crystal grains present in the second region may be greater than a number of crystal grains present in the first region.

The magnetic layer may include a third region surrounding the second region and having a degree of crystallinity different from those of the first and second regions.

The magnetic layer may include crack portions formed in the first and second regions.

The crack portions may be separated by a constant interval.

The surface of the magnetic layer in the crack portions may be fragmented.

Each of the crack portions may include fragments.

A number of the fragments in the crack portions of the first region may be different than a number of the fragments in the crack portions of the second region.

A degree of crystallinity in the second region may be higher than a degree of crystallinity in the first region, and the crack portions of the second region may be fragmented at a greater rate than the crack portions of the first region.

The first and second regions may be heat-treated at different temperatures.

The first and second regions may have different thicknesses.

An average size of a crystal grain of the first and second regions may be different from each other.

In another general aspect, there is provided an electronic device including a coil member including a coil region, and a magnetic sheet disposed adjacently to the coil member and including a magnetic layer formed of a metal, the magnetic layer including first and second regions having different degrees of crystallinity from each other.

The coil member may include a first coil region and a second coil region, and the first coil region and the second coil region may be disposed in positions corresponding to the first and second regions, respectively.

Other features and aspects will be apparent from the following detailed description, the drawings, and the claims.

### BRIEF DESCRIPTION OF DRAWINGS

FIG. 1 is a diagram illustrating an example of a wireless charging apparatus.

FIG. 2 is a diagram illustrating an example of some internal components of the wireless charging apparatus of FIG. 1.

FIG. 3 is a diagram illustrating an example of a magnetic sheet.

FIG. 4 is a diagram illustrating an example of region A in the magnetic sheet of FIG. 3.

FIG. 5 is a diagram illustrating an example of the magnetic sheet of FIG. 3 and illustrates an example where coils are disposed on the magnetic sheet.

FIGS. 6 and 7 are diagrams illustrating examples of magnetic sheets.

FIGS. 8 and 9 are diagrams illustrating examples of a method of manufacturing a magnetic sheet.

FIG. 10 is a diagram illustrating an example of a magnetic sheet obtained by a pressing process of FIG. 9.

FIG. 11 is a diagram illustrating an example of the method of manufacturing a magnetic sheet.

FIG. 12 is a diagram illustrating and example of a magnetic sheet obtained by a process of FIG. 11.

Throughout the drawings and the detailed description, the same reference numerals refer to the same elements. The drawings may not be to scale, and the relative size, proportions, and depiction of elements in the drawings may be exaggerated for the purposes of clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after gaining a thorough an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

Throughout the specification, when an element, such as a layer, region, or substrate, is described as being “on,” “connected to,” “coupled to,” “over,” or “covering” another element, it may be directly “on,” “connected to,” “coupled to,” “over,” or “covering” the other element, or there may be one or more other elements intervening therebetween. In contrast, when an element is described as being “directly on,” “directly connected to,” “directly coupled to,” “directly over,” or “directly covering” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items.

Due to manufacturing techniques and/or tolerances, variations of the shapes shown in the drawings may occur. Thus, the examples described herein are not limited to the specific shapes shown in the drawings, but include changes in shape that occur during manufacturing.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

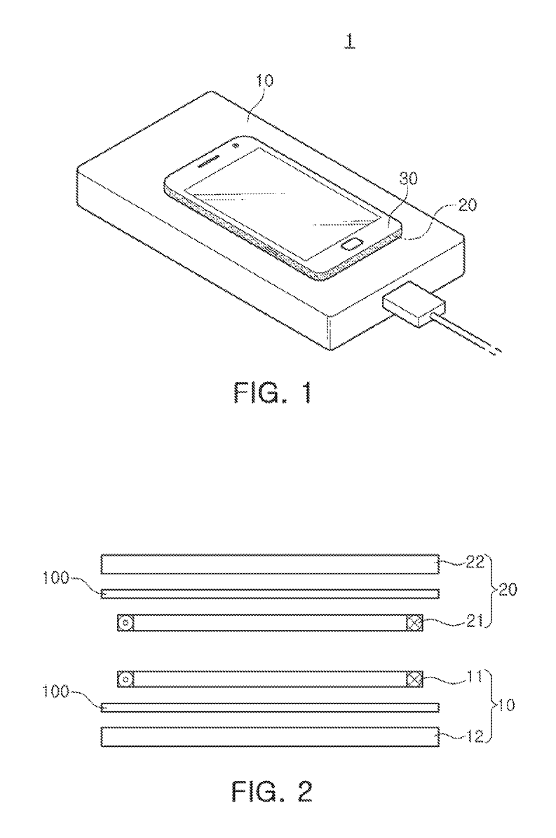

FIG. 1 is a diagram illustrating an example of a wireless charging apparatus 1, and FIG. 2 is an example of a diagram illustrating some internal components of FIG. 1.

Referring to FIGS. 1 and 2, in an example, the wireless charging apparatus 1 includes a wireless power transmitting apparatus 10 and a wireless power receiving apparatus 20. In an example, the wireless power receiving apparatus 20 is embodied or incorporated in various types of products 30 such as, for example, an intelligent agent, a mobile phone, a cellular phone, a smart phone, a wearable smart device (such as, a ring, a watch, a pair of glasses, glasses-type device, a bracelet, an ankle bracket, a belt, a necklace, an earring, a headband, a helmet, a device embedded in the cloths, or an eye glass display (EGD)), a server, a personal computer (PC), a laptop, a notebook, a subnotebook, a netbook, an ultra-mobile PC (UMPC), a tablet personal computer (tablet), a phablet, a mobile internet device (MID), a personal digital assistant (PDA), an enterprise digital assistant (EDA), a digital camera, a digital video camera, a portable game console, an MP3 player, a portable/personal multimedia player (PMP), a handheld e-book, an ultra mobile personal computer (UMPC), a portable lab-top PC, a global positioning system (GPS) navigation, a personal navigation device, portable navigation device (PND), a handheld game console, an e-book, a high definition television (HDTV), a smart appliance, communication systems, image processing systems, graphics processing systems, various Internet of Things (loT) devices that are controlled through a network, a smart vehicle, an intelligent automobile, an autonomous driving vehicle, other consumer electronics/information technology (CE/IT) device, or any other device capable of wireless communication or network communication consistent with that disclosed herein.

In an example, the wireless power transmitting apparatus 10 includes a transmission coil member 11 formed on a substrate 12. When an alternating current (AC) voltage is applied to the wireless power transmitting apparatus 10, a magnetic field is formed in the vicinity of the wireless power transmitting apparatus 10. Electromotive force may be induced from the transmission coil member 11 into a reception coil member 21 embedded in the wireless power receiving apparatus 20, such that a battery 22 may be charged.

In an example, the battery 22 is a nickel metal hydride battery or a lithium ion battery that is rechargeable. Other batteries are considered to be well within the scope of the present disclosure. In an example, the battery 22 is separate from the wireless power receiving apparatus 20, and is detachable from the wireless power receiving apparatus 20. In another example, the battery 22 is in an integral form where it is configured integrally with the wireless power receiving apparatus 20.

The transmission coil member 11 and the reception coil member 21 may be electromagnetically coupled to each other, may be formed by winding a metal wire formed of material, such as, for example, copper. The transmission coil member 11 and the reception coil member 21 may be configured in a variety of shapes, such as, a circular shape, an oval shape, a quadrangular shape, an elliptical shape, a hexagonal shape, and a rhombic shape. In an example, the sizes, the turns of the transmission coil member 11 and the reception coil member 21 may be appropriately controlled and set depending on requirements.

Magnetic sheets 100 may be disposed between the reception coil member 21 and the battery 22 and between the transmission coil member 11 and the substrate 12, respectively. When the magnetic sheet 100 is disposed in a reception side, the magnetic sheet 100 may shield a magnetic flux formed at a central portion of the transmission coil member 11. When the magnetic sheet 100 is disposed in a reception side, the magnetic sheet 100 may be positioned between the reception coil member 21 and the battery 22 and collect a magnetic flux to allow the magnetic flux to be efficiently received in the reception coil member 21. In an example, the magnetic sheet 100 blocks at least some of the magnetic flux from arriving at the battery 22.

The magnetic sheet 100 may be coupled to a coil member in a reception part or the transmission part of the wireless charging apparatus described above. The magnetic sheet 100 may also be used in magnetic secure transmission (MST), near field communications (NFC), or the like, in addition to the wireless charging apparatus. Both of the transmission coil member and the reception coil member will hereinafter be referred to as coil members when they do not need to be distinguished from each other. The magnetic sheet 100 will be described in more detail.

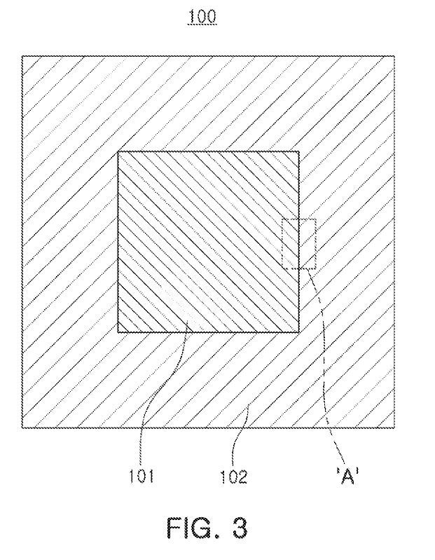

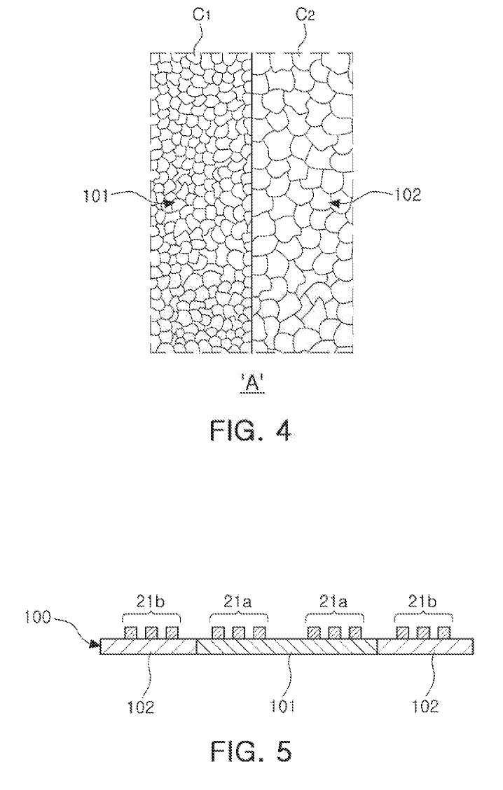

FIG. 3 is a diagram illustrating an example of a magnetic sheet. FIG. 4 is an example of an enlarged view illustrating region A in the magnetic sheet of FIG. 3. FIG. 5 is a diagram illustrating an example of a cross-sectional view of the magnetic sheet of FIG. 3 and illustrates a form in which coils are disposed on the magnetic sheet.

Referring to FIGS. 3 through 5, the magnetic sheet 100 includes one or more magnetic layers formed of a metal, and an example in which a single magnetic layer is used will be described. Since the magnetic sheet 100 includes a single magnetic layer in the examples, the magnetic sheet 100 may also be referred to as the magnetic layer. A plurality of magnetic layers 100 may also be used in order to improve a shielding effect.

In an example, the magnetic layer 100 is formed of a metal, and may be a material having a magnetic property to be appropriate for shielding electromagnetic waves, such as, for example, an amorphous alloy, or a nanocrystalline alloy. In an example, the amorphous alloy is a Iron(Fe)-based or Cobalt(Co)-based magnetic alloy. In an example, a material including Si, for example, a Fe—Si—B alloy may be used as the Fe based magnetic alloy. As a content of metal including Fe in the Fe—Si—B alloy increases, a saturation magnetic flux density increases. However, when a content of Fe elements is excessive, it is difficult to form an amorphous alloy. Therefore, in an example, the content of Fe may be 70 to 90 atomic percent, and the sum of contents of Si and B in the amorphous alloy is in a range of 10 to 30 atomic percent. In an example, 20 atomic percent or less of a corrosion resistant element such as, for example, Chromium (Cr) or Co is added to such a basic composition to prevent corrosion. In an example, a small amount of other metal elements may be added to provide other characteristics, as needed.

In another example, when the magnetic layer 100 is implemented using the nanocrystalline alloy, for example, an Iron based nanocrystalline magnetic alloy may be used. In an example, an Fe—Si—B—Cu—Nb alloy is used as the Iron based nanocrystalline magnetic alloy. In this case, an amorphous metal ribbon may be heat-treated at an appropriate temperature in order to form the nanocrystalline alloy.

In an example, as shown in FIG. 3, the magnetic layer 100 includes a first region 101 and a second region 102. In an example, degrees of crystallinity of the first and second regions 101 and 102 are different from each other. Here, a phrase “the degrees of crystallinity are different from each other” means that grain sizes, crystal distributions, and the like, of crystal grains in the first and second regions 101 and 102 are different from each other. In an example, the crystallinity of each region of the magnetic layer 110 formed of the metal is determined by a temperature at which the amorphous alloy is heat-treated. For example, heat-treat temperatures of the amorphous alloys in the first and second regions 101 and 102 may be controlled to be different from each other, such that the amorphous alloys in the first and second regions 101 and 102 may be crystallized at different temperatures.

Since the first and second regions 101 and 102 have the different degrees of crystallinity, even when the first and second regions 101 and 102 are formed of the same material, the first and second regions 101 and 102 may have different degrees of magnetic permeability. The first and second regions 101 and 102 having the different degrees of magnetic permeability may perform different functions, i.e., frequencies of electromagnetic waves that may be shielded in the first and second regions 101 and 102 may be different from each other.

As illustrated in FIG. 3, the first region 101 may be disposed in a central portion of the magnetic layer 100, and the second region 102 may be disposed to surround the first region 101. In this case, the second region 102 may have a degree of crystallinity higher than a degree of crystallinity of the first region 101. As illustrated in FIG. 4, crystal grains C2 of the second region 102 may be larger than crystal grains C1 of the first region 101. In an example, an average size of a crystal grain of the first region 101 is different than an average size of a crystal grain of the second region 102. The first and second regions 101 and 102 having the different degrees of crystallinity and degrees of magnetic permeability may be coupled to coil patterns performing different functions. For example, the first region 101 may be used as a shielding part for wireless power charging, and the second region 102 may be used as a shielding part for near field communications.

FIG. 5 illustrates an example where coil regions 21a and 21b are disposed on the magnetic sheet 100. Crystallinity and magnetic permeability characteristics of the first and second regions 101 and 102 may be adopted in consideration of positions of the coil regions 21a and 21b. For example, the coil regions 21a and 21b may be disposed on the magnetic sheet 100. The first and second coil regions 21a and 21b may be independently driven. In an example, the first and second coil regions 21a and 21b may be disposed in positions corresponding to the first and second regions 101 and 102, respectively.

In the example shown in FIG. 4, a line divides the first and second regions 101 and 102, but the first and second regions 101 and 102 may be continuously formed without being divided. In other words, the first and second regions 101 and 102 may share some of the crystal gains with each other at a boundary the regions. In an example, crystallinity tendencies of the first and second regions 101 and 102 may be varied, as needed. In an example, the first region 101 disposed in the central portion of the magnetic layer has a degree of crystallinity higher than a degree of crystallinity of the second region 102.

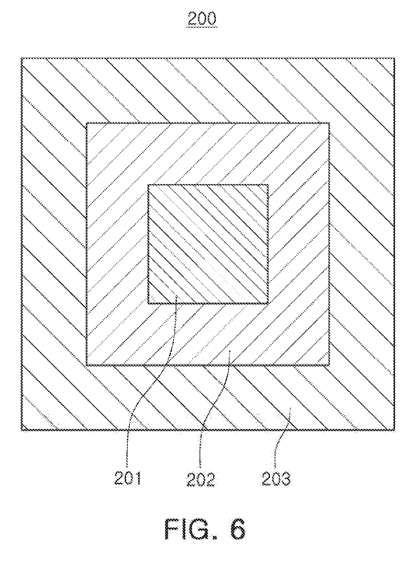

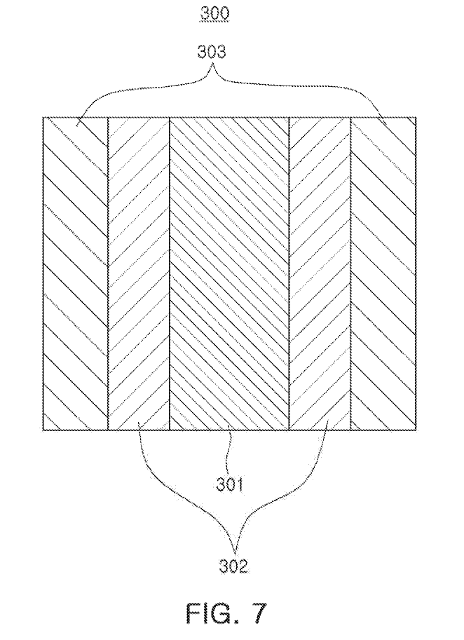

FIGS. 6 and 7 are diagrams illustrating examples of magnetic sheets. In the examples of FIGS. 6 and 7, a magnetic layer may include three regions, each region having different degrees of crystallinity. Referring to FIG. 6, in an example, a magnetic layer 200 includes first to third regions 201 to 203, and the first to third regions 201 to 203 may each have different degrees of crystallinity and degrees of magnetic permeability. In an example, the first region 201 is disposed in a central portion of the magnetic layer 200, the second region 202 is disposed to surround the first region 201, and the third region 203 is disposed at the outermost portion of the magnetic layer 200 to surround the second region 202. The first region 201 may be a shielding part for wireless power charging, the second region 202 may be a shielding part for magnetic secure transmissions, and the third region 203 may be a shielding part for near field communications.

In the example of FIG. 7, a magnetic layer 300 includes first to third regions 301 to 303, and the first to third regions 301 to 303 may have different degrees of crystallinity and degrees of magnetic permeability. In an example, the first region 301 is disposed in a central portion of the magnetic layer 300, the second regions 302 is disposed to surround the first region 301, and the third regions 303 is disposed to surround the second regions 302. In the example of FIG. 7, the first to third regions 301 to 303 may have a stripe shape, and the second regions 302 may surround two opposing surfaces of the first region 301, and the third regions 303 may also surround two opposing surfaces of the second regions 302.

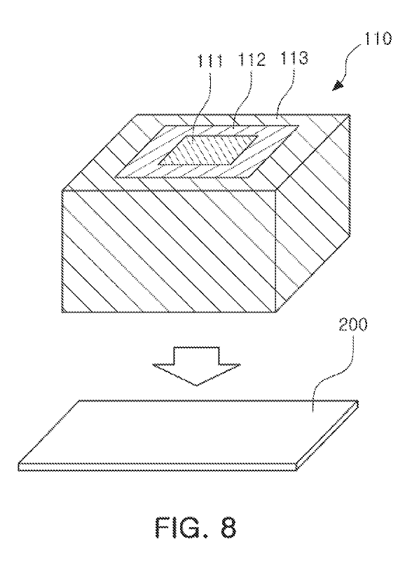

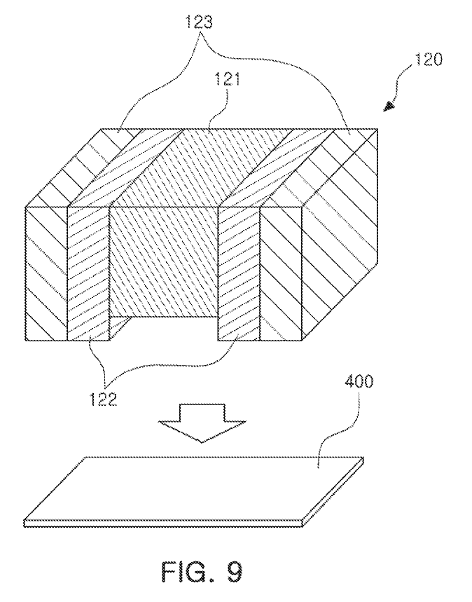

As described above, the magnetic layer may be heat-treated at different temperatures in each region to have different degrees of crystallinity in each region. For example, presses having different temperatures may be used to provide heat-treated at different temperatures in each region. This will be described with reference to FIGS. 8 and 9. First, in a form illustrated in FIG. 8, a press 110 includes three pressing regions 111 to 113, which may have different temperatures. For example, temperatures increase from the first pressing region 111 toward the third pressing region 113. In another example, temperatures decrease from the first pressing region 111 toward the third pressing region 113. In another example, a temperature of the central region 112 is the highest. However, other temperature distributions of the pressing regions 111 to 113 are considered to be well within the scope of the present disclosure.

The press 110 having different temperatures in each region may be applied to a magnetic sheet 200 to form crystallination temperatures in each region of the magnetic sheet 200 to be different from each other, thereby adjusting degrees of crystallinity in each region of the magnetic sheet 200. In an example, the magnetic sheet 200 crystallized by the application of the press 110 includes the first to third regions 201 to 203 having different degrees of crystallinity, as illustrated in FIG. 6. In this case, a form of the press 100 may be appropriately designed depending on an intended form of regions of the magnetic sheet.

In a form illustrated in FIG. 9, a press 120 includes three pressing regions 121 to 123, which may have different temperatures. For example, temperatures increase from the first pressing region 121 toward the third pressing region 123. In another example, temperatures decrease from the first pressing region 121 toward the third pressing region 123. However, other temperature distributions of the pressing regions 121 to 123 are considered to be well within the scope of the present disclosure.

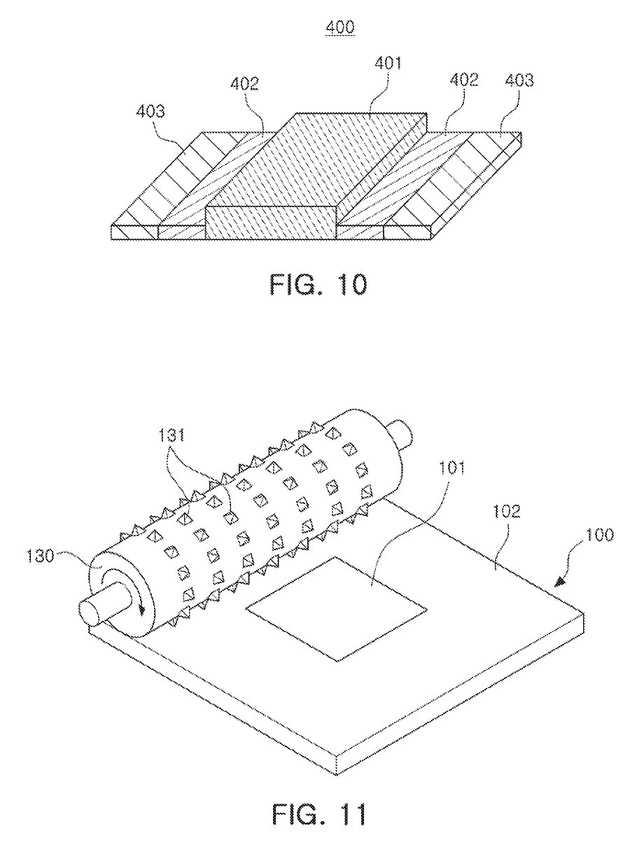

In the example of FIG. 9, a partial step structure may be formed in the press 120, and a step structure having a shape corresponding to that of the partial step structure may also be formed in a magnetic sheet 400. In a form illustrated in FIG. 9, the press 120 may have a depressed form in the first pressing region 121. FIG. 10 illustrates a magnetic sheet obtained by a pressing process of FIG. 9. The magnetic sheet 400 includes first to third regions 401 to 403 having different degrees of crystallinity. In addition, some of the first to third regions 401 to 403 may have different thicknesses due to application of the press 120 having the step structure. In a form illustrated in FIG. 10, the first region 401 may be thicker than that of the second and third regions 402 and 403 to have a protruding form.

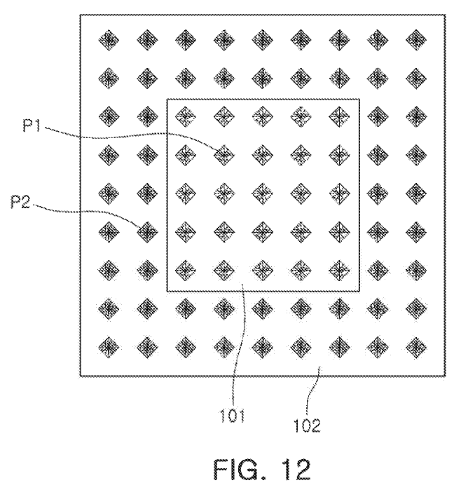

Another example is described with reference to FIGS. 11 and 12. FIG. 11 is a diagram illustrating an example of the method of manufacturing a magnetic sheet, and FIG. 12 is a diagram illustrating an example of a magnetic sheet obtained by a process of FIG. 11.

FIG. 11 illustrates a process of forming crack portions by applying a roller 130 to a surface of the magnetic sheet 100. The roller 130 is provided to form the crack portions or depressions in the magnetic sheet 100, and may have a form in which a plurality of protrusions 131 are formed on a surface of a body that is rotatable. In an, the protrusions 131 may have a pyramid shape as in a form illustrated in FIG. 11. The examples shown in FIG. 11 are only a non-exhaustive illustrations of the pyramid shape of the protrusions 131. Other shapes of the protrusions 131, such as, for example conical shape, a pillar shape, or a polypyramidal shape, are considered to be well within the scope of the present disclosure.

In an example, the roller 130 having the protrusions 131 formed on its surface, forms the crack portions having a shape corresponding to that of the protrusions 131 in the magnetic sheet 100 while the roller is rotating and moving on the magnetic sheet 100. In an example, the plurality of protrusions 131 may have a regular form to form the crack portions. The regular form means a case in which features, such as, for example, shapes, pitches, array forms of the plurality of protrusions 131 are regular. For example, the plurality of protrusions 131 may be regularly arranged in a state in which they are spaced apart from each other, adjacent protrusions to have a constant interval between each other, and distances between the protrusions 131 is uniform.

As described above, when the magnetic sheet 100 is manufactured using a fragmentation tool that may generate regular fragmentation, for example, the roller 131 of FIG. 11, a structure of the magnetic sheet 100 may be adjusted, such that magnetic characteristics of the magnetic sheet 100 such as a magnetic permeability, or the like, is adjusted, and structural reproducibility and stability of the magnetic sheet 100 is raised. In an example, the magnetic sheet 100 described above with reference to FIG. 3 is described by way of example, and the roller 130 may also be applied to other types of magnetic sheets.

As illustrated in FIG. 12, when the roller 130 having the form described above is applied, a plurality of crack portions P1 and P2 are formed in a magnetic layer. In an example, the plurality of crack portions P1 and P2 may be formed in both of the first and second regions 101 and 102. Because the protrusions 131 of the roller 130 have the constant interval therebetween, and the plurality of crack portions P1 and P2 may thus also have a constant interval therebetween. The plurality of crack portions P1 and P2 may have a form in which a surface of the magnetic layer is fragmented. For example, as in a form illustrated in FIG. 12, each of the plurality of crack portions P1 and P2 may include a plurality of fragments. In an example, since degrees of crystallinity of the first and second regions 101 and 102 in the magnetic layer are different from each other, even though the same roller 130 is applied to the first and second regions 101 and 102, fragmentation characteristics of the first and second regions 101 and 102 may be different from each other. Fragmented levels of the crack portions P1 of the first region 101 and the crack portions P2 of the second region 102 are different from each other. When a crystallinity of the second region 102 is higher than that of the first region 101 as in an example of FIG. 3, the crack portions P2 of the second region 102 may be fragmented at a greater level as compared to the crack portions P1 of the first region 101. For example, a larger number of fragments may be included in the crack portions P2 of the second region 102 than in the crack portions P1 of the first region 101, and sizes of the fragments included in the crack portions P2 may be smaller than those of the fragments included in the crack portions P1 of the first region 101.

As described above, since the first and second regions 101 and 102 having the different degrees of crystallinity are used, even though the roller 130 having the protrusions 131 generally having the same shape and the constant interval is applied to the magnetic sheet 100, the fragmented levels of the first and second regions 101 and 102 are different from each other. Degrees of magnetic permeability of the first and second regions 101 and 102 having the different fragmented levels may be more effectively adjusted.

As set forth above, the magnetic sheet according to the present disclosure may be used in various frequency ranges to significantly increase utilization of a space in an electronic product. As set forth above, a single magnetic sheet capable of being used in various frequency ranges, and an electronic device including the same is provided.

While this disclosure includes specific examples, it will be apparent after gaining a thorough an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A magnetic sheet comprising:
a magnetic layer formed of a metal,
wherein the magnetic layer comprises first and second regions having different degrees of crystallinity from each other.

2. The magnetic sheet of claim 1, wherein the first and the second region have different degrees of magnetic permeability.

3. The magnetic sheet of claim 1, wherein the first region is disposed in a central portion of the magnetic layer, and the second region surrounds the first region.

4. The magnetic sheet of claim 3, wherein a degree of crystallinity of the second region is higher than a degree of crystallinity of the first region.

5. The magnetic sheet of claim 3, wherein a number of crystal grains present in the second region is greater than a number of crystal grains present in the first region.

6. The magnetic sheet of claim 3, wherein the magnetic layer further comprises a third region surrounding the second region and having a degree of crystallinity different from those of the first and second regions.

7. The magnetic sheet of claim 1, wherein the magnetic layer further comprises crack portions formed in the first and second regions.

8. The magnetic sheet of claim 7, wherein the crack portions are separated by a constant interval.

9. The magnetic sheet of claim 7, wherein a surface of the magnetic layer in the crack portions are fragmented.

10. The magnetic sheet of claim 9, wherein each of the crack portions comprises fragments.

11. The magnetic sheet of claim 10, wherein a number of the fragments in the crack portions of the first region is different than a number of the fragments in the crack portions of the second region.

12. The magnetic sheet of claim 11, wherein a degree of crystallinity in the second region is higher than a degree of crystallinity in the first region, and the crack portions of the second region are fragmented at a greater rate than the crack portions of the first region.

13. The magnetic sheet of claim 1, wherein the first and second regions are heat-treated at different temperatures.

14. The magnetic sheet of claim 1, wherein the first and second regions have different thicknesses.

15. The magnetic sheet of claim 1, wherein an average size of a crystal grain of the first and second regions are different from each other.

16. An electronic device comprising:
a coil member comprising a coil region; and
a magnetic sheet disposed adjacently to the coil member and comprising a magnetic layer formed of a metal, the magnetic layer comprising first and second regions having different degrees of crystallinity from each other.

17. The electronic device of claim 16, wherein the coil member comprises a first coil region and a second coil region, and the first coil region and the second coil region are disposed in positions corresponding to the first and second regions, respectively.
